(19) United States
(12) Patent Application Publication
(10) Pub. No.: US 2015/0261486 A1
(43) Pub. Date: Sep. 17, 2015

(54) IMAGE PROCESSING APPARATUS AND IMAGE PROCESSING METHOD

(71) Applicant: Atsushi SHINDOH, Kanagawa (JP)

(72) Inventor: Atsushi SHINDOH, Kanagawa (JP)

(73) Assignee: Ricoh Company, Limited, Tokyo (JP)

(21) Appl. No.: 14/657,625

(22) Filed: Mar. 13, 2015

(30) Foreign Application Priority Data
Mar. 17, 2014 (JP) 2014-054224

(51) Int. Cl. G06F 3/12; G06K 15/02

(52) U.S. Cl. CPC G06F 3/1242; G06F 3/122; G06F 3/1248; G06F 3/1246; G06K 15/1807; G06K 15/1815; H04N 2201/0094

(57) ABSTRACT

An image processing apparatus includes a command analysis unit and a drawing processing unit. The command analysis unit receives a drawing command for generating drawing data, and analyzes whether or not the drawing command thus received is a virtual frame drawing command for drawing a virtual frame. When the drawing command is the virtual frame drawing command, the command analysis unit converts the virtual frame drawing command into a frame definition command for defining a frame for drawing, and a second drawing command for performing a drawing process included in drawing contents of the virtual frame drawing command. The drawing processing unit generates the drawing data according to the second drawing command.

### CROSS-REFERENCE TO RELATED APPLICATIONS

The present application claims priority to and incorporates by reference the entire contents of Japanese Patent Application No. 2014-054224 filed in Japan on Mar. 17, 2014.

### BACKGROUND OF THE INVENTION

1. Field of the Invention

The present invention relates to an image processing apparatus and an image processing method.

2. Description of the Related Art

In recent years, PDF (Portable Document Format) or XPS (XML Document Specification), which is a format based on XML (Extensible Markup Language), is adopted as the format for electronic documents capable of accurately expressing images and the like regardless of the model or environment of a computer.

At the time of printing electronic documents created in these formats with a page printer, PDL (Page Description Language) data is used, and in many cases, the PDL data for PDF, XPS or the like supports a virtual frame function as language specification.

By using the virtual frame function, it becomes possible to swiftly draw a complicated drawing object which was drawn once without having to draw the object from a scratch, and printers have to cope with the situation.

However, in order to add the virtual frame draw function to a drawing object (images, graphics) which can be drawn with a conventional image processing apparatus, a component such as a circuit to be installed in the image processing apparatus becomes necessary, and the scale is increased.

The present invention has been made in view of the above situation, and its main object is to provide an image processing apparatus and an image processing method which are capable of realizing the virtual frame draw function while suppressing an increase in the apparatus scale.

### SUMMARY OF THE INVENTION

It is an object of the present invention to at least partially solve the problems in the conventional technology.

An image processing apparatus includes a command analysis unit and a drawing processing unit. The command analysis unit receives a drawing command for generating drawing data, and analyzes whether or not the drawing command thus received is a virtual frame drawing command for drawing a virtual frame. When the drawing command is the virtual frame drawing command, the command analysis unit converts the virtual frame drawing command into a frame definition command for defining a frame for drawing, and a second drawing command for performing a drawing process included in drawing contents of the virtual frame drawing command. The drawing processing unit generates the drawing data according to the second drawing command.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration diagram of an image forming apparatus and a controller according to a present embodiment;

FIG. 2 is a block diagram illustrating a functional configuration of a drawing unit of the present embodiment;

FIG. 3 is a diagram for describing virtual frame drawing of the present embodiment;

FIG. 4 is a flow chart illustrating the procedure of a printing process of the present embodiment;

FIG. 5 is a flow chart illustrating the procedure of a drawing process of the present embodiment; and

FIG. 6 is a flow chart illustrating the procedure of a virtual frame drawing process of the present embodiment.

### DETAILED DESCRIPTION OF THE PREFERRED EMBODIMENTS

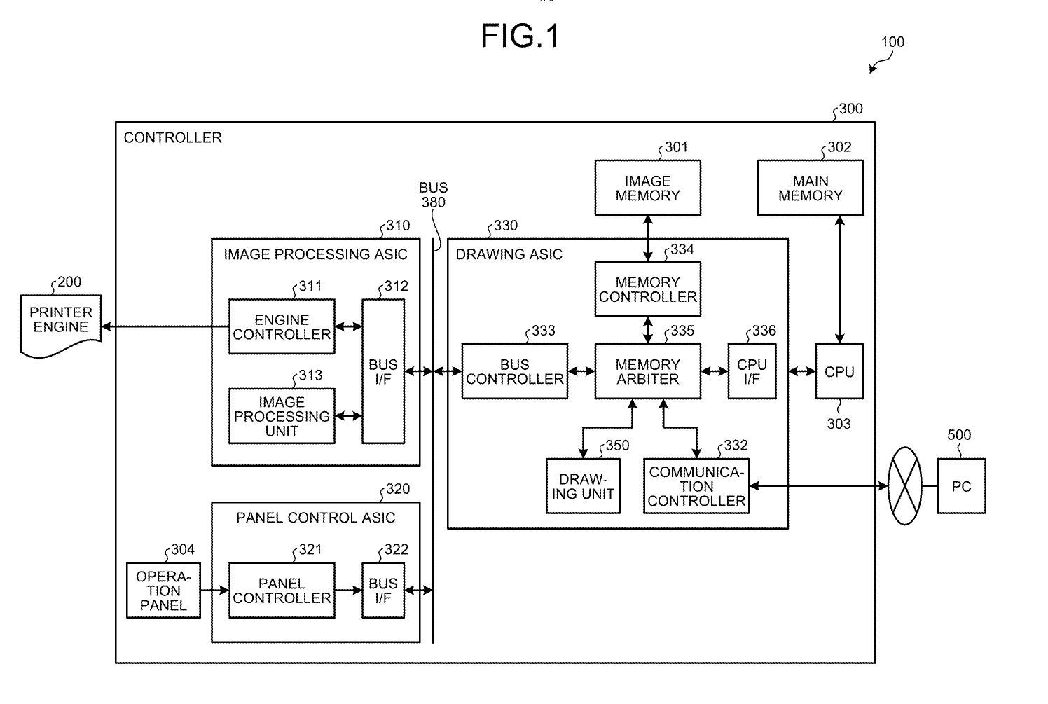

Hereinafter, an embodiment will be described in detail with reference to the appended drawings. FIG. 1 is a configuration diagram of an image forming apparatus and a controller according to the present embodiment. The image forming apparatus of the present embodiment is a copier, a printing device, a multifunction peripheral provided with a copying function or a printing function, or the like, and is an example of an image processing apparatus. Additionally, the image processing apparatus is not limited to the image forming apparatus.

As illustrated in FIG. 1, an image forming apparatus 100 of the present invention mainly includes a printer engine 200 and a controller 300. The printer engine 200 performs printing. The controller 300 controls the entire image forming apparatus 100, and a printer controller board corresponds to the same, for example. Also, according to the image forming apparatus 100, the controller 300 is connected to a PC (Personal Computer) 500 via a network.

As illustrated in FIG. 1, a drawing ASIC 330, an image processing ASIC 310, a panel control ASIC 320, an operation panel 304, an image memory 301, a main memory 302, and a CPU (Central Processing Unit) 303 are installed in the controller 300.

The drawing ASIC 330, the image processing ASIC 310, and the panel control ASIC 320 are connected via a bus 380. This bus 380 is compliant with the AXI (Advanced eXtensible Interface) specification, but is not restricted to be such.

The drawing ASIC 330 is connected to the image memory 301 and the CPU 303, and the CPU 303 is connected to the main memory 302.

The operation panel 304 is provided with a liquid crystal display panel which is capable of displaying various screens to a user and receiving input by a touch operation, operation keys which can be operated by a user, and the like.

The CPU 303 controls the entire apparatus of the image forming apparatus 100. Also, the CPU 303 analyzes PDL data that is transmitted from the PC 500, and performs output of a drawing command to the drawing ASIC 330, generation of parameters for the image processing ASIC 310, and the like.

The image processing ASIC 310 applies image processing on printing target image data that is received from the drawing ASIC 330, and also, outputs print data to the printer engine 200. As illustrated in FIG. 1, the image processing ASIC 310 is provided with an engine controller 311, an image processing unit 313, and a bus I/F 312.

The bus I/F 312 is a communication interface via the bus to the panel control ASIC 320 and the drawing ASIC 330. The engine controller 311 controls the printer engine 200. The image processing unit 313 applies various types of image processing on printing target image data that is received from the drawing ASIC 330, and outputs printing data to the printer engine 200.

As illustrated in FIG. 1, the panel control ASIC 320 is provided with a panel controller 321, and a bus I/F 322.

The bus I/F 322 is a communication interface via the bus (an AXI bus) to the image processing ASIC 310 and the drawing ASIC 330. The panel controller 321 controls input/output to/from the operation panel 304.

As illustrated in FIG. 1, the drawing ASIC 330 is provided with a memory controller 334, a bus controller 333, a memory arbiter 335, a CPU I/F 336, a drawing unit 350, and a communication controller 332.

The memory arbiter 335 performs arbitration of access to the image memory 301 by each controller of the drawing ASIC 330. The memory controller 334 is connected to each controller via the memory arbiter 335. The bus controller 333 performs arbitration between each controller which inputs/outputs data to/from the bus and the bus. The CPU I/F 336 is an interface to the CPU 303.

The communication controller 332 is connected to a network, and receives each piece of data, commands and the like transmitted from the PC 500 or the like that is connected via the network. Also, the communication controller 332 outputs received data and the like to each controller that is connected via the memory arbiter 335, and transmits data and the like input from each controller to the PC 500 and the like.

The drawing unit 350 performs drawing of image data based on a drawing command generated by analysis of input PDL data. The drawing unit 350 saves the image data to be drawn in the image memory 301.

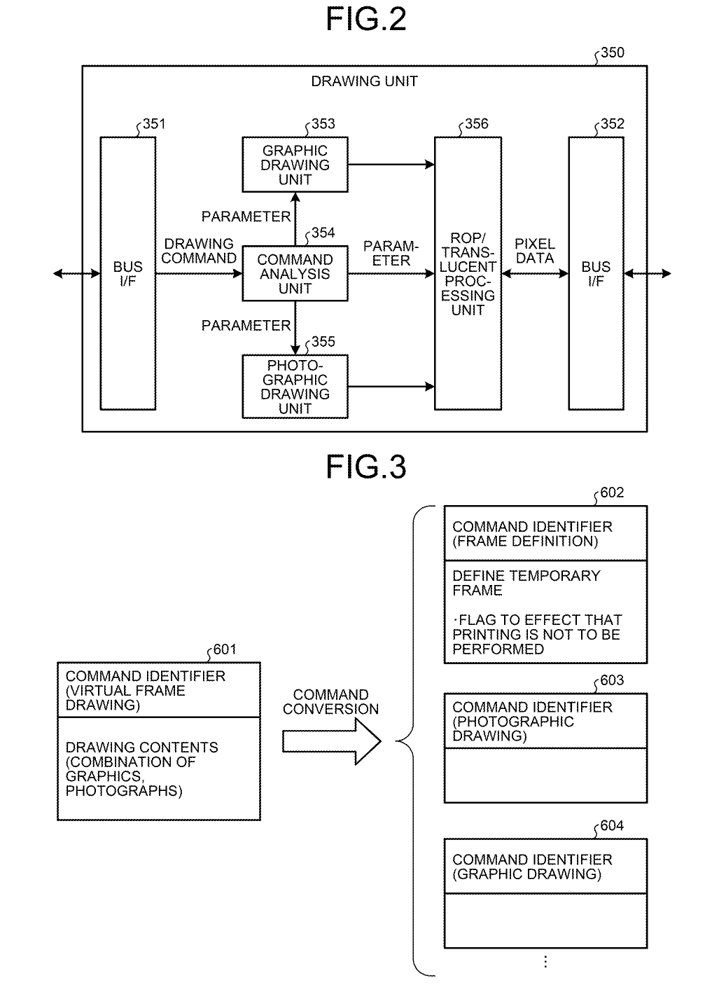

FIG. 2 is a block diagram illustrating a functional configuration of the drawing unit 350 of the present embodiment. As illustrated in FIG. 2, the drawing unit 350 is provide with bus I/Fs 351 and 352, a command analysis unit 354, a graphic drawing unit 353, a photographic drawing unit 355, and a ROP (Raster Operation)/translucent processing unit 356. Here, the graphic drawing unit 353, the photographic drawing unit 355, and the ROP/translucent processing unit 356 are examples of the drawing processing unit. The drawing unit 350 is configured by hardware such as an electronic circuit, an FPGA (Field-Programmable Gate Array), or the like.

The bus I/Fs 351 and 352 are interfaces for accessing the image memory 301 via the memory arbiter 335 and the memory controller 334. The bus I/F 351 receives a drawing command generated by the CPU 303 based on PDL data, and transmits the same to the command analysis unit 354. The drawing command here is a command for generating drawing data.

The bus I/F 352 performs reading of pixel data necessary for drawing from the image memory 301, and writing of a drawing result to the image memory 301.

The command analysis unit 354 receives a drawing command from the bus I/F 351, and analyzes whether or not the received drawing command is a virtual frame drawing command. The virtual frame drawing command here is a command for drawing a virtual frame.

A virtual frame function is a function enabling collective drawing or processing of a drawing command and a group in a drawn state, and is a function enabling a virtual frame to be repeatedly drawn on another virtual frame or a page. A virtual frame allows drawing of a combination of drawing objects in a region different from a page (frame) which is the final drawing result, and usage of the result drawn in the other region as one drawing object.

That is, a virtual frame is a drawing object, and a drawing object is an arbitrary combination of photographic drawings (images), drawings of lines (graphics) and the like assembled as one drawing unit. By using such virtual frame function, a complicated drawing object which was drawn once may be swiftly drawn without having to be drawn from a scratch.

If, according to the result of analysis of a drawing command by the command analysis unit 354, the drawing command is a virtual frame drawing command, the virtual frame drawing command is converted into a frame definition command and a regular drawing processing command for performing a drawing process included in the drawing contents of the virtual frame drawing command.

The frame definition command is a command for defining a frame to be drawn by photographic drawing, graphic drawing or the like. Also, a photographic drawing command for photographic drawing and a graphic drawing command for graphic drawing correspond to the regular drawing processing command. That is, in the case where a drawing command is a virtual frame drawing command, the command analysis unit 354 converts the virtual frame drawing command into the frame definition command, and at least one of the photographic drawing command and the graphic drawing command.

In this manner, according to the present embodiment, a virtual frame drawing command is converted into a regular (existing) frame definition command, graphic drawing command, or photographic drawing command not according to the virtual frame function, and thus, a processing unit (a virtual frame drawing unit or the like) for performing a process regarding virtual frame drawing based on a virtual frame drawing command is not provided to the drawing unit 350.

In the following, virtual frame drawing using a regular drawing processing command according to the present embodiment will be described. FIG. 3 is a diagram for describing the virtual frame drawing of the present embodiment. In the present embodiment, a unique processing unit (a virtual frame drawing unit or the like) for handling the virtual frame drawing process is not provided to the drawing unit 350 or the like, and thus, drawing based solely on the virtual frame drawing command is not performed.

Instead, if the command analysis unit 354 determines that a drawing command is a virtual frame drawing command, conversion into a regular drawing processing command is performed. At this time, the format of a photograph (image) to be used in a photographic drawing process is defined to be the same as that of the format of a frame to be used for printing.

A virtual frame is a virtual frame not to be printed, and thus, as illustrated in FIG. 3, the command analysis unit 354 replaces a virtual frame drawing command 601 by a regular (existing) frame definition command 602, and adds a flag to the effect that printing is not to be performed to the contents of the frame definition command 602.

Furthermore, as illustrated in FIG. 3, the drawing content (a combination of photographic drawing and graphic drawing) of the virtual frame drawing command 601 is an individual drawing process itself, and thus, the command analysis unit 354 replaces the virtual frame drawing command 601 by a graphic drawing command 604 or a photographic drawing command 603 depending on the drawing contents.

Moreover, with respect to a process of performing drawing in a frame which is supposed to be printed from a virtual frame which is already drawn, this may be handled by an existing photographic drawing command by causing the contents of the virtual frame to have the same format as the photograph which is used for photographic drawing.

Additionally, in the case of command conversion of the present embodiment, since a frame itself to be used for printing may also be treated as a photograph for the photographic drawing process, the memory may be saved and the drawing time may be reduced at the time of drawing already drawn contents over and over.

As a specific example of printing data, there may be cited a case of putting a company logo to all the pages of a document.

Referring back to FIG. 2, the command analysis unit 354 transmits a converted command to a corresponding processing unit (the graphic drawing unit 353 or the photographic drawing unit 355) as a parameter. Specifically, the command analysis unit 354 generates a frame for drawing according to the frame definition command. Then, the command analysis unit 354 transmits the graphic drawing command to the graphic drawing unit 353 as a parameter, and transmits the photographic drawing command to the photographic drawing unit 355 as a parameter.

The graphic drawing unit 353 performs, on the frame for drawing generated by the command analysis unit 354, according to the graphic drawing command received from the command analysis unit 354, Scanline drawing according to which pieces of data indicating whether or not to put a dot in the frame are arranged in a line, and Rect drawing of drawing a rectangle by repeating the same Scanline drawing over and over.

The photographic drawing unit 355 performs a process of pasting a specified photograph (image) in the frame for drawing generated by the command analysis unit 354, according to the photographic drawing command received from the command analysis unit 354.

The ROP/translucent processing unit 356 superimposes the object drawn according to the photographic drawing command and the object drawn according to the graphic drawing command, and generates pixel data as drawing data. The ROP/translucent processing unit 356 transmits the generated pixel data to the bus I/F 352.

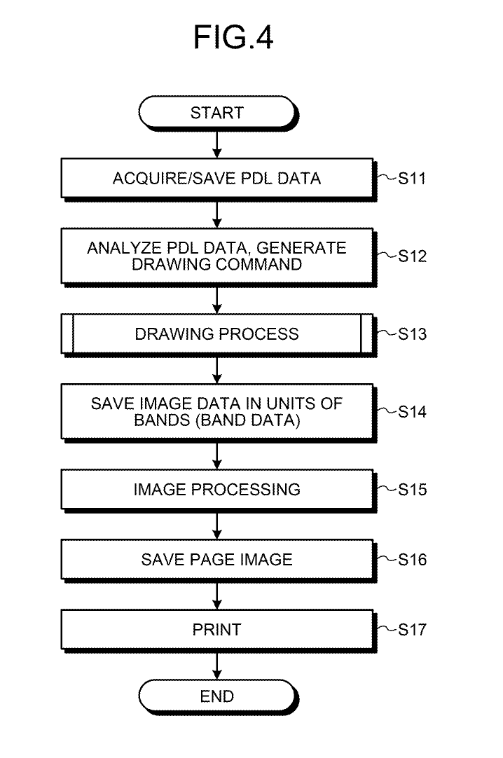

Next, a printing process of the present embodiment configured in the above manner will be described. FIG. 4 is a flow chart illustrating the procedure of the printing process of the present embodiment. FIG. 4 illustrates the flow from input of PDL data to output from the printer engine. Additionally, in the description below, the process that is mainly performed by the CPU 303 is implemented by the CPU 303 executing a program.

First, the CPU 303 acquires PDL data generated from print target image data from the PC 500 or the like via the network, and saves the acquired PDL data in the main memory 302 (step S11). Next, the CPU 303 reads the PDL data that is saved in the main memory 302, analyzes the PDL data which has been read, and generates a drawing command (step S12).

Next, the drawing unit 350 executes the drawing command, and draws image data that is expressed in RGB color space (step S13). Details of the drawing process by the drawing unit 350 will be given later. The drawing unit 350 saves the generated image data in the image memory 301 in units of bands (step S14). Here, a band is a unit of image processing by the image forming apparatus 100, and image data in a band of unit is referred to as band data.

Next, the image processing unit 313 of the image processing ASIC 310 acquires the band data that is saved in the image memory 301 from the drawing ASIC 330, and the image processing unit 313 of the image processing ASIC 310 performs image processing on the band data (step S15). Specifically, the image processing unit 313 performs color conversion on the band data, that is, the RGB image data in a unit of band, into image data in a color space of CMYK, and moreover, performs halftone processing (gradation processing), and generates a page image taking data obtained by performing color conversion and gradation processing on a plurality of pieces of band data as an image per page.

Next, the image processing unit 313 saves the page image in the image memory 301 (step S16). Then, the engine controller 311 transmits the page image in the image memory 301 to the printer engine 200, and the printer engine 200 prints and outputs image data in units of pages (step S17).

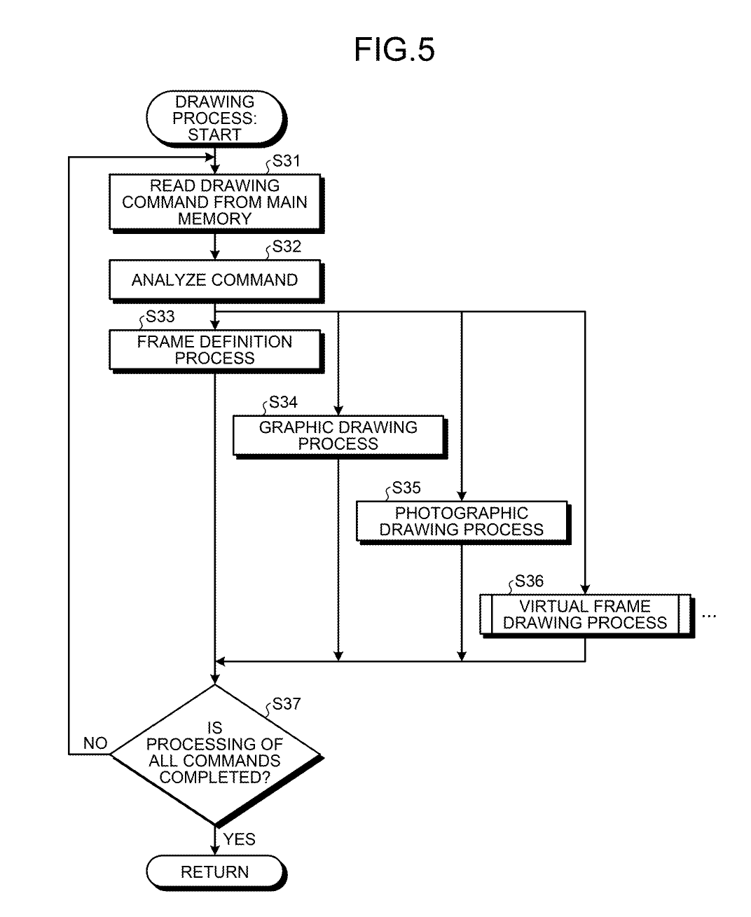

Next, details of the drawing process by the drawing unit 350 in step S13 will be given. FIG. 5 is a flow chart illustrating the procedure of the drawing process of the present embodiment.

The command analysis unit 354 of the drawing unit 350 reads the drawing command that is stored in the main memory 302 (step S31). Then, the command analysis unit 354 analyzes the drawing command which has been read (step S32). Next, depending on the contents of the analyzed drawing command, a process according to each of the drawing commands of a frame (page) definition process (step S33), a photographic drawing process (step S35), a graphic drawing process (step S34), and a virtual frame drawing process (step S36) is performed.

Now, the frame definition process in step S33 is performed by the command analysis unit 354 in the case where the drawing command is a frame definition command. The photographic drawing process in step S35 is performed by the photographic drawing unit 355 in the case where the drawing command is a photographic drawing command. The graphic drawing process in step S34 is performed by the graphic drawing unit 353 in the case where the drawing command is a graphic drawing command. The virtual frame drawing process in step S36 is performed in the case where the drawing command is a virtual frame drawing command. Details of the virtual frame drawing process will be given later.

Then, the command analysis unit 354 determines whether or not processing of all the drawing commands saved in the main memory 302 is completed (step S37), and returns to step S31 in the case of incompletion (step S37: No), and the processes from step S31 to step S36 are repeated. On the other hand, in the case where processing of all the drawing commands is completed (step S37: Yes), the process is ended.

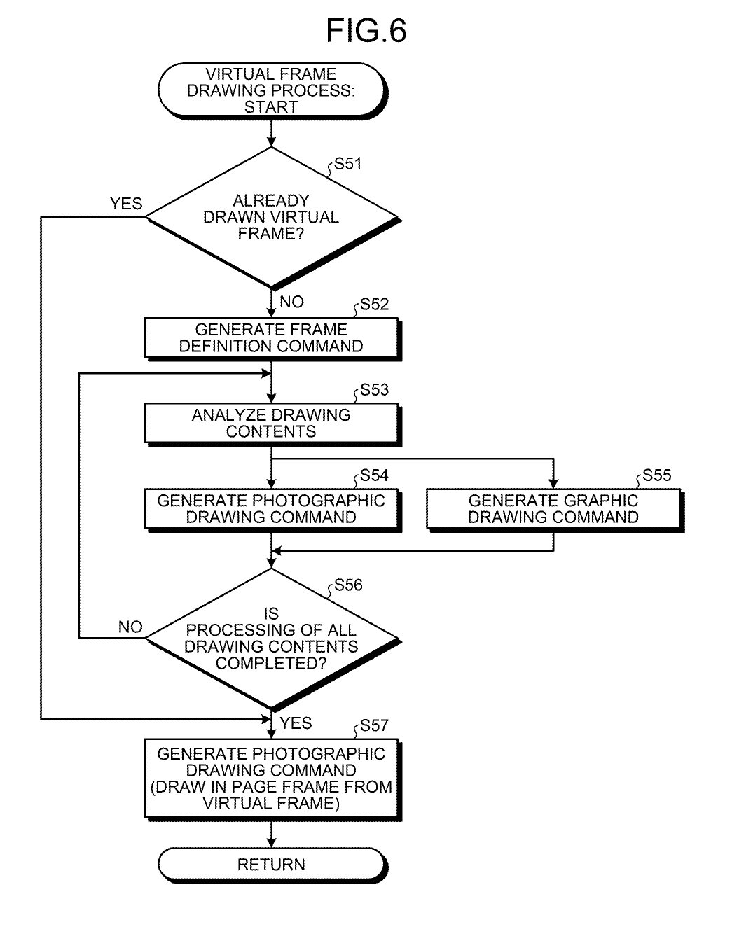

Next, details of the virtual frame drawing process in step S36 will be given. FIG. 6 is a flow chart illustrating the procedure of the virtual frame drawing process of the present embodiment.

The command analysis unit 354 first determines whether or not a virtual frame specified by the virtual frame drawing command is a virtual frame which has already been drawn (step S51). Then, in the case of a virtual frame which is already drawn (step S51: Yes), the process proceeds to step S57.

On the other hand, in the case of a virtual frame which is not yet drawn, that is, a virtual frame which is not yet defined (step S51: No), the command analysis unit 354 generates a frame definition command (step S52). At this time, as illustrated in FIG. 3 and as described above, the command analysis unit 354 writes a flag to the effect that printing is not to be performed in the contents of the frame definition command.

Next, the command analysis unit 354 analyzes the drawing contents of the virtual frame drawing command (step S53). Then, the process branches into processes for generating respective drawing commands. Specifically, in the case where the photographic drawing is in the drawing contents of the virtual frame drawing command, the command analysis unit 354 generates a photographic drawing command (step S54). In the case where there is graphic drawing in the drawing contents of the virtual frame drawing command, the command analysis unit 354 generates a graphic drawing command (step S55).

Next, the command analysis unit 354 determines whether or not the processing is finished for all the drawing contents in the virtual frame drawing command (step S56). Then, in the case where the processing is not finished for all the drawing contents (step S56: No), the process returns to step S53, and the process of drawing command generation is repeated.

On the other hand, in the case where, in step S56, the processing is finished for all the drawing contents in the virtual frame drawing command (step S56: Yes), the command analysis unit 354 generates a photographic drawing command for drawing in a page frame that is to be actually printed from the virtual frame (step S57), and the process is ended.

The frame definition command generated in step S52 is executed by the command analysis unit 354. At this time, since a flag to the effect that printing is not to be performed is set in the contents of the frame definition command, this flag is referred to, and printing is not performed solely by a defined frame, as in the case of a virtual frame. The photographic drawing command generated in step S54 is transmitted by the command analysis unit 354 to the photographic drawing unit 355 as a parameter, and is executed by the photographic drawing unit 355. The graphic drawing command generated in step S55 is transmitted by the command analysis unit 354 to the graphic drawing unit 353 as a parameter, and is executed by the graphic drawing unit 353.

In this manner, according to the present embodiment, in the case where a drawing command is a virtual frame drawing command, the command analysis unit 354 converts the virtual frame drawing command into an existing drawing command, and thus, the process of virtual frame drawing may be realized simply by adding a command conversion process to the hardware of the existing drawing unit 350. Therefore, according to the present embodiment, virtual frame drawing may be achieved by a gate scale smaller than in the case of adding new hardware such as a circuit for virtual frame drawing. In other words, according to the present embodiment, the virtual frame draw function may be achieved while suppressing an increase in the circuit scale of the apparatus.

Also, according to the present embodiment, virtual frame drawing is processed by the drawing unit 350 configured by hardware, and the speed of the drawing process may be increased.

Additionally, in the present embodiment, conversion of a virtual frame drawing command into an existing drawing command is performed by the command analysis unit 354, but this is not restrictive. For example, this command conversion may be performed by a circuit such as a command conversion unit different from the command analysis unit 354.

According to the present invention, there is achieved an effect that the virtual frame draw function is realized while an increase in the apparatus scale is suppressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a command analysis unit to
receive a drawing command for generating drawing data,
analyze whether or not the drawing command thus received is a virtual frame drawing command for drawing a virtual frame, and
convert, when the drawing command is the virtual frame drawing command, the virtual frame drawing command into a frame definition command for defining a frame for drawing, and a second drawing command for performing a drawing process included in drawing contents of the virtual frame drawing command; and
a drawing processing unit to generate the drawing data according to the second drawing command.

2. The image processing apparatus according to claim 1, wherein, depending on the drawing contents of the virtual frame drawing command, the command analysis unit converts the virtual frame drawing command into at least one of a photographic drawing command for photographic drawing and a graphic drawing command for graphic drawing as the second drawing command.

3. The image processing apparatus according to claim 2, wherein the command analysis unit uses data of a page frame as a photograph to be used for photographic drawing.

4. The image processing apparatus according to claim 2, wherein the drawing processing unit generates the drawing data by superimposing an object drawn according to the photographic drawing command and an object drawn according to the graphic drawing command.

5. The image processing apparatus according to claim 1, wherein the command analysis unit is configured by hardware.

6. An image processing method comprising:
receiving a drawing command for generating drawing data;
analyzing whether or not the drawing command thus received is a virtual frame drawing command for drawing a virtual frame;
converting, when the drawing command is the virtual frame drawing command, the virtual frame drawing command into a frame definition command for defining a frame for drawing, and a second drawing command for performing a drawing process included in drawing contents of the virtual frame drawing command; and
generating the drawing data according to the second drawing command.
